(19) United States
(12) Patent Application Publication
(10) Pub. No.: US 2014/0280436 A1
(43) Pub. Date: Sep. 18, 2014

(54) MIGRATION TOOL FOR IMPLEMENTING DESKTOP VIRTUALIZATION

(71) Applicant: CITRIX SYSTEMS, INC., Fort Lauderdale, FL (US)

(72) Inventors: Michael Larkin, San Jose, CA (US); Anupam Rai, Fremont, CA (US); Vikramjeet Singh Sandhu, Bangalore (IN)

(73) Assignee: CITRIX SYSTEMS, INC., Fort Lauderdale, FL (US)

(21) Appl. No.: 13/826,820

(22) Filed: Mar. 14, 2013

(51) Int. Cl. H04L 29/08

(52) U.S. Cl. CPC H04L 67/10
USPC 709/201

(57) ABSTRACT

At least a method and a system for migrating a plurality of endpoint computing devices of an organization are described herein. User applications, data, and settings are migrated from a plurality of endpoint computing devices of the organization into a client server operating environment employing a thin client implementation. A server may execute software for deploying the thin client implementation. By way of creating a personalized virtualization disk for each endpoint computing device, migration to a thin client virtualized desktop implementation may be easily performed by the organization without modification, change, or loss of user installed applications, personalized settings, and user data.

### FIELD

Aspects described herein generally relate to computers and virtualization of computer systems. More specifically, aspects described herein provide methods and systems for migrating a plurality of computing devices residing in one or more networks to a client server operating environment employing a thin client architecture.

### BACKGROUND

Customers can find it challenging to deploy virtual machine implementations or architectures across their entire enterprise due to the complexity of transforming their existing environments into those deploying a thin client architecture. For example, a customer may wish to deploy a thin client solution but likely has hundreds, if not thousands, of computing devices in its organization, where each endpoint computing device may comprise a physical PC (personal computer). Depending on the management configuration of these PC's, each of these PCs may be installed with its own unique data, applications, settings, and other data.

When migrating the computing devices in the organization to a thin client architecture, an end user of a client computing device may be annoyed or dissatisfied if one or more applications used within his desktop environment disappears or if the configuration and/or settings of the one or more applications has changed after the migration or transformation has been performed. When this occurs, the one or more applications may have to be reinstalled and reconfigured to the end user's preferences. Furthermore, the end user may be further dissatisfied if his desktop environment is changed or altered during the transformation process.

### BRIEF SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

To overcome limitations in the prior art described above, and to overcome other limitations that will be apparent upon reading and understanding the present specification, aspects described herein are directed to migrating a plurality of endpoint computing devices of an organization into a client server operating environment employing a thin client implementation. The migration tool allows, among other things, for an easy adoption and migration to a virtual desktop infrastructure by way of deploying a thin client architecture.

Aspects described herein provide for collecting data from each endpoint computing device of a plurality of endpoint computing devices using one or more telemetry gathering agents, creating a personalized virtualization disk based on the data for each endpoint computing device, and using the personalized virtualization disk to implement a thin client virtualized desktop. The personalized virtualization disk is used to generate one or more user installed applications, user data, and user settings corresponding to each endpoint computing device.

Some aspects described herein provide for the creation of a personalized virtualization disk for each endpoint computing device by de-installing software from an image based on collected data, in which the software comprises an operating system and one or more applications that are commonly used throughout the plurality of endpoint computing devices.

### BRIEF DESCRIPTION OF THE DRAWINGS

A more complete understanding of aspects described herein and the advantages thereof may be acquired by referring to the following description in consideration of the accompanying drawings, in which like reference numbers indicate like features, and wherein:

FIG. 1 depicts an illustrative computer system architecture that may be used in accordance with one or more illustrative aspects described herein.

FIG. 2 depicts an illustrative remote-access system architecture that may be used in accordance with one or more illustrative aspects described herein.

FIG. 3 depicts an illustrative virtualized system architecture that may be used in accordance with one or more illustrative aspects described herein.

FIG. 4 depicts an illustrative cloud-based system architecture that may be used in accordance with one or more illustrative aspects described herein.

FIG. 5 depicts an operational flow diagram for providing a method of migrating applications, data, and settings from a plurality of computing devices of an organization into a client server operating environment employing a thin client implementation.

FIG. 6 depicts an operational flow diagram for providing a method of generating a personalized virtualization disk (PVD) for each of one or more endpoints (or endpoint computing devices) of an organization.

FIG. 7 depicts an operational flow diagram for providing a method of generating a personalized virtualization disk (PVD) for an endpoint of one or more endpoints (or endpoint computing devices) of an organization.

### DETAILED DESCRIPTION

In the following description of the various embodiments, reference is made to the accompanying drawings identified above and which form a part hereof, and in which is shown by way of illustration various embodiments in which aspects described herein may be practiced. It is to be understood that other embodiments may be utilized and structural and functional modifications may be made without departing from the scope described herein. Various aspects are capable of other embodiments and of being practiced or being carried out in various different ways.

As a general introduction to the subject matter described in more detail below, aspects described herein provide methods, systems, and computer readable media for migrating applications, data, and settings from a plurality of computing devices of an organization into a client server operating environment employing a thin client implementation. A server may execute software for deploying the thin client implementation. When the software is executed, one or more virtual machines may be implemented and deployed to one or more clients. After the migration, the one or more clients may utilize the same or similar hardware associated with the plurality of computing devices. Otherwise, each of the clients may be implemented with a minimum amount of hardware required to implement the thin client architecture. The plurality of computing devices may be replaced with one or more thin client computing devices comprising a circuitry which provides minimal processing power, thereby maximizing cost savings to the organization.

Prior to the migration, the plurality of computing devices may comprise personal computers (PCs), laptops, notebooks, notepad, mobile communications device, and the like. Each of the plurality of computing devices may be defined as an endpoint. A personal virtualization disk (PVD) layer or image may be created for each endpoint based on information obtained from each of the plurality of computing devices. The PVD image may comprise user data, user settings, and user installed applications. The information or data used to create a PVD image may be obtained using a telemetry gathering agent installed at each of the plurality of computing devices. After completing the migration, telemetry may be gathered by a telemetry gathering agent on an ongoing basis as a way to obtain endpoint statistics by an administrator of the organization.

After creating the PVD image associated with the migration, the server may be executed to implement a plurality of virtualized desktops throughout the organization. To implement each of the virtualized desktops, a corresponding PVD layer may be executed at the server to generate all of the applications, user settings, and user data that were uniquely used by each of computing device of the plurality of computing devices prior to the migration.

It is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. The use of the terms “mounted,” “connected,” “coupled,” “positioned,” “engaged” and similar terms, is meant to include both direct and indirect mounting, connecting, coupling, positioning and engaging.

Computer software, hardware, and networks may be utilized in a variety of different system environments, including standalone, networked, remote-access (aka, remote desktop), virtualized, and/or cloud-based environments, among others. FIG. 1 illustrates one example of a system architecture and data processing device that may be used to implement one or more illustrative aspects of the invention in a standalone and/or networked environment. Various network nodes 103, 105, 107, and 109 may be interconnected via a wide area network (WAN) 101, such as the Internet. Other networks may also or alternatively be used, including private intranets, corporate networks, LANs, metropolitan area networks (MAN) wireless networks, personal networks (PAN), and the like. Network 101 is for illustration purposes and may be replaced with fewer or additional computer networks. A local area network (LAN) may have one or more of any known LAN topology and may use one or more of a variety of different protocols, such as Ethernet. Devices 103, 105, 107, 109 and other devices (not shown) may be connected to one or more of the networks via twisted pair wires, coaxial cable, fiber optics, radio waves or other communication media.

The term “network” as used herein and depicted in the drawings refers not only to systems in which remote storage devices are coupled together via one or more communication paths, but also to stand-alone devices that may be coupled, from time to time, to such systems that have storage capability. Consequently, the term “network” includes not only a “physical network” but also a “content network,” which is comprised of the data—attributable to a single entity—which resides across all physical networks.

The components may include data server 103, web server 105, and client computers 107, 109. Data server 103 provides overall access, control and administration of databases and control software for performing one or more illustrative aspects of the invention as described herein. Data server 103 may be connected to web server 105 through which users interact with and obtain data as requested. Alternatively, data server 103 may act as a web server itself and be directly connected to the Internet. Data server 103 may be connected to web server 105 through the network 101 (e.g., the Internet), via direct or indirect connection, or via some other network. Users may interact with the data server 103 using remote computers 107, 109, e.g., using a web browser to connect to the data server 103 via one or more externally exposed web sites hosted by web server 105. Client computers 107, 109 may be used in concert with data server 103 to access data stored therein, or may be used for other purposes. For example, from client device 107 a user may access web server 105 using an Internet browser, as is known in the art, or by executing a software application that communicates with web server 105 and/or data server 103 over a computer network (such as the Internet).

Servers and applications may be combined on the same physical machines, and retain separate virtual or logical addresses, or may reside on separate physical machines. FIG. 1 illustrates just one example of a network architecture that may be used, and those of skill in the art will appreciate that the specific network architecture and data processing devices used may vary, and are secondary to the functionality that they provide, as further described herein. For example, services provided by web server 105 and data server 103 may be combined on a single server.

Each component 103, 105, 107, 109 may be any type of known computer, server, or data processing device. Data server 103, e.g., may include a processor 111 controlling overall operation of the rate server 103. Data server 103 may further include RAM 113, ROM 115, network interface 117, input/output interfaces 119 (e.g., keyboard, mouse, display, printer, etc.), and memory 121. I/O 119 may include a variety of interface units and drives for reading, writing, displaying, and/or printing data or files. Memory 121 may further store operating system software 123 for controlling overall operation of the data processing device 103, control logic 125 for instructing data server 103 to perform aspects of the invention as described herein, and other application software 127 providing secondary, support, and/or other functionality which may or may not be used in conjunction with aspects of the present invention. The control logic may also be referred to herein as the data server software 125. Functionality of the data server software may refer to operations or decisions made automatically based on rules coded into the control logic, made manually by a user providing input into the system, and/or a combination of automatic processing based on user input (e.g., queries, data updates, etc.).

Memory 121 may also store data used in performance of one or more aspects of the invention, including a first database 129 and a second database 131. In some embodiments, the first database may include the second database (e.g., as a separate table, report, etc.). That is, the information can be stored in a single database, or separated into different logical, virtual, or physical databases, depending on system design. Devices 105, 107, 109 may have similar or different architecture as described with respect to device 103. Those of skill in the art will appreciate that the functionality of data processing device 103 (or device 105, 107, 109) as described herein may be spread across multiple data processing devices, for example, to distribute processing load across multiple computers, to segregate transactions based on geographic location, user access level, quality of service (QoS), etc. The data server 103 may comprise a virtualization server 301 as described in connection with FIG. 3.

One or more aspects may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as described herein may be transferred between a source and a destination in the form of electromagnetic waves traveling through signal-conducting media such as metal wires, optical fibers, and/or wireless transmission media (e.g., air and/or space). Various aspects described herein may be embodied as a method, a data processing system, or a computer program product. Therefore, various functionality may be embodied in whole or in part in software, firmware and/or hardware or hardware equivalents such as integrated circuits, field programmable gate arrays (FPGA), and the like. Particular data structures may be used to more effectively implement one or more aspects of the invention, and such data structures are contemplated within the scope of computer executable instructions and computer-usable data described herein.

With further reference to FIG. 2, one or more aspects described herein may be implemented in a remote-access environment. FIG. 2 depicts an example system architecture including a generic computing device 201 in an illustrative computing environment 200 that may be used according to one or more illustrative aspects described herein. Generic computing device 201 may be used as a server 206a in a single-server or multi-server desktop virtualization system (e.g., a remote access or cloud system) configured to provide virtual machines for client access devices. The generic computing device 201 may have a processor 203 for controlling overall operation of the server and its associated components, including random access memory (RAM) 205, read-only memory (ROM) 207, input/output (I/O) module 209, and memory 215.

I/O module 209 may include a mouse, keypad, touch screen, scanner, optical reader, and/or stylus (or other input device(s)) through which a user of generic computing device 201 may provide input, and may also include one or more of a speaker for providing audio output and a video display device for providing textual, audiovisual, and/or graphical output. Software may be stored within memory 215 and/or other storage to provide instructions to processor 203 for configuring generic computing device 201 into a special purpose computing device in order to perform various functions as described herein. For example, memory 215 may store software used by the computing device 201, such as an operating system 217, application programs 219, and an associated database 221.

Computing device 201 may operate in a networked environment supporting connections to one or more remote computers, client machines, client devices, client computing devices, client, or terminals 240. The terminals 240 may comprise personal computers, mobile devices, laptop computers, tablets, or servers that include many or all of the elements described above with respect to the generic computing device 103 or 201. The network connections depicted in FIG. 2 include a local area network (LAN) 225 and a wide area network (WAN) 229, but may also include other networks. When used in a LAN networking environment, computing device 201 may be connected to the LAN 225 through a network interface or adapter 223. When used in a WAN networking environment, computing device 201 may include a modem 227 or other wide area network interface for establishing communications over the WAN 229, such as computer network 230 (e.g., the Internet). It will be appreciated that the network connections shown are illustrative and other means of establishing a communications link between the computers may be used. Computing device 201 and/or terminals 240 may also be mobile terminals (e.g., mobile phones, smartphones, PDAs, notebooks, etc.) including various other components, such as a battery, speaker, and antennas (not shown).

Aspects described herein may also be operational with numerous other general purpose or special purpose computing system environments or configurations. Examples of other computing systems, environments, and/or configurations that may be suitable for use with aspects described herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

As shown in FIG. 2, one or more client devices 240 may be in communication with one or more servers 206a-206n (generally referred to herein as “server(s) 206”). In one embodiment, the computing environment 200 may include a network appliance installed between the server(s) 206 and client machine(s) 240. The network appliance may manage client/server connections, and in some cases can load balance client connections amongst a plurality of backend servers 206.

The client machine(s) 240 may in some embodiments be referred to as a single client machine 240 or a single group of client machines 240, while server(s) 206 may be referred to as a single server 206 or a single group of servers 206. In one embodiment a single client machine 240 communicates with more than one server 206, while in another embodiment a single server 206 communicates with more than one client machine 240. In yet another embodiment, a single client machine 240 communicates with a single server 206.

A client machine 240 can, in some embodiments, be referenced by any one of the following non-exhaustive terms: client machine(s); client(s); client computer(s); client device(s); client computing device(s); local machine; remote machine; client node(s); endpoint(s); or endpoint node(s). The server 206, in some embodiments, may be referenced by any one of the following non-exhaustive terms: server(s), local machine; remote machine; server farm(s), or host computing device(s).

In one embodiment, the client machine 240 may be a virtual machine. The virtual machine may be any virtual machine, while in some embodiments the virtual machine may be any virtual machine managed by a Type 1 or Type 2 hypervisor, for example, a hypervisor developed by Citrix Systems, IBM, VMware, or any other hypervisor. In some aspects, the virtual machine may be managed by a hypervisor, while in aspects the virtual machine may be managed by a hypervisor executing on a server 206 or a hypervisor executing on a client 240.

Some embodiments include a client device 240 that displays application output generated by an application remotely executing on a server 206 or other remotely located machine. In these embodiments, the client device 240 may execute a virtual machine receiver program or application to display the output in an application window, a browser, or other output window. In one example, the application is a desktop, while in other examples the application is an application that generates or presents a desktop. A desktop may include a graphical shell providing a user interface for an instance of an operating system in which local and/or remote applications can be integrated. Applications, as used herein, are programs that execute after an instance of an operating system (and, optionally, also the desktop) has been loaded.

The server 206, in some embodiments, uses a remote presentation protocol or other program to send data to a thin-client or remote-display application executing on the client to present display output generated by an application executing on the server 206. The thin-client or remote-display protocol can be any one of the following non-exhaustive list of protocols: the Independent Computing Architecture (ICA) protocol developed by Citrix Systems, Inc. of Ft. Lauderdale, Fla.; or the Remote Desktop Protocol (RDP) manufactured by the Microsoft Corporation of Redmond, Wash.

A remote computing environment may include more than one server 206a-206n such that the servers 206a-206n are logically grouped together into a server farm 206, for example, in a cloud computing environment. The server farm 206 may include servers 206 that are geographically dispersed while and logically grouped together, or servers 206 that are located proximate to each other while logically grouped together. Geographically dispersed servers 206a-206n within a server farm 206 can, in some embodiments, communicate using a WAN (wide), MAN (metropolitan), or LAN (local), where different geographic regions can be characterized as: different continents; different regions of a continent; different countries; different states; different cities; different campuses; different rooms; or any combination of the preceding geographical locations. In some embodiments the server farm 206 may be administered as a single entity, while in other embodiments the server farm 206 can include multiple server farms.

In some embodiments, a server farm may include servers 206 that execute a substantially similar type of operating system platform (e.g., WINDOWS, UNIX, LINUX, iOS, ANDROID, SYMBIAN, etc.) In other embodiments, server farm 206 may include a first group of one or more servers that execute a first type of operating system platform, and a second group of one or more servers that execute a second type of operating system platform.

Server 206 may be configured as any type of server, as needed, e.g., a file server, an application server, a web server, a proxy server, an appliance, a network appliance, a gateway, an application gateway, a gateway server, a virtualization server, a deployment server, a SSL VPN server, a firewall, a web server, an application server or as a master application server, a server executing an active directory, or a server executing an application acceleration program that provides firewall functionality, application functionality, or load balancing functionality. Other server types may also be used.

Some embodiments include a first server 206a that receives requests from a client machine 240, forwards the request to a second server 206b, and responds to the request generated by the client machine 240 with a response from the second server 206b. First server 206a may acquire an enumeration of applications available to the client machine 240 and well as address information associated with an application server 206 hosting an application identified within the enumeration of applications. First server 206a can then present a response to the client's request using a web interface, and communicate directly with the client 240 to provide the client 240 with access to an identified application. One or more clients 240 and/or one or more servers 206 may transmit data over network 230, e.g., network 101.

FIG. 2 shows a high-level architecture of an illustrative desktop virtualization system. As shown, the desktop virtualization system may be single-server or multi-server system, or cloud system, including at least one virtualization server 206 configured to provide virtual desktops and/or virtual applications to one or more client access devices 240. As used herein, a desktop refers to a graphical environment or space in which one or more applications may be hosted and/or executed. A desktop may include a graphical shell providing a user interface for an instance of an operating system in which local and/or remote applications can be integrated. Applications may include programs that execute after an instance of an operating system (and, optionally, also the desktop) has been loaded. Each instance of the operating system may be physical (e.g., one operating system per device) or virtual (e.g., many instances of an OS running on a single device). Each application may be executed on a local device, or executed on a remotely located device (e.g., remoted).

With further reference to FIG. 3, a computer device 301 may be configured as a virtualization server in a virtualization environment such as, for example, a single-server, multi-server, or cloud computing environment. Virtualization server 301 illustrated in FIG. 3 can be deployed as and/or implemented by one or more embodiments of the server 206 illustrated in FIG. 2 or by other known computing devices. Included in virtualization server 301 is a hardware layer that can include one or more physical disks 304, one or more physical devices 306, one or more physical processors 308 and one or more physical memories 316. In some embodiments, firmware 312 can be stored within a memory element in the physical memory 316 and can be executed by one or more of the physical processors 308. Virtualization server 301 may further include an operating system 314 that may be stored in a memory element in the physical memory 316 and executed by one or more of the physical processors 308. Still further, a hypervisor 302 may be stored in a memory element in the physical memory 316 and can be executed by one or more of the physical processors 308.

Executing on one or more of the physical processors 308 may be one or more virtual machines 332A-C (generally 332). Each virtual machine 332 may have a virtual disk 326A-C and a virtual processor 328A-C. In some embodiments, a first virtual machine 332A may execute, using a virtual processor 328A, a control program 320 that includes a tools stack 324. Control program 320 may be referred to as a control virtual machine, Dom0, Domain 0, or other virtual machine used for system administration and/or control. In some embodiments, one or more virtual machines 332B-C can execute, using a virtual processor 328B-C, a guest operating system 330A-B.

Virtualization server 301 may include a hardware layer 310 with one or more pieces of hardware that communicate with the virtualization server 301. In some embodiments, the hardware layer 310 can include one or more physical disks 304, one or more physical devices 306, one or more physical processors 308, and physical memory 316. Physical components 304, 306, 308, and 316 may include, for example, any of the components described above. Physical devices 306 may include, for example, a network interface card, a video card, a keyboard, a mouse, an input device, a monitor, a display device, speakers, an optical drive, a storage device, a universal serial bus connection, a printer, a scanner, a network element (e.g., router, firewall, network address translator, load balancer, virtual private network (VPN) gateway, Dynamic Host Configuration Protocol (DHCP) router, etc.), or any device connected to or communicating with virtualization server 301. Physical memory 316 in the hardware layer 310 may include any type of memory. Physical memory 316 may store data, and in some embodiments may store one or more programs, or set of executable instructions. FIG. 3 illustrates an embodiment where firmware 312 is stored within the physical memory 316 of virtualization server 301. Programs or executable instructions stored in the physical memory 316 can be executed by the one or more processors 308 of virtualization server 301.

Virtualization server 301 may also include a hypervisor 302. In some embodiments, hypervisor 302 may be a program executed by processors 308 on virtualization server 301 to create and manage any number of virtual machines 332. Hypervisor 302 may be referred to as a virtual machine monitor, or platform virtualization software. In some embodiments, hypervisor 302 can be any combination of executable instructions and hardware that monitors virtual machines executing on a computing machine. Hypervisor 302 may be Type 2 hypervisor, where the hypervisor that executes within an operating system 314 running on the virtualization server 301. Virtual machines then execute at a level above the hypervisor. In some embodiments, the Type 2 hypervisor executes within the context of a user's operating system such that the Type 2 hypervisor interacts with the user's operating system. In other embodiments, the virtualization server 301 in a virtualization environment may instead include a Type 1 hypervisor (Not Shown). A Type 1 hypervisor may execute on the virtualization server 301 by directly accessing the hardware and resources within the hardware layer 310. That is, while a Type 2 hypervisor 302 accesses system resources through a host operating system 314, as shown, a Type 1 hypervisor may directly access all system resources without the host operating system 314. A Type 1 hypervisor may execute directly on one or more physical processors 308 of virtualization server 301, and may include program data stored in the physical memory 316.

Hypervisor 302, in some embodiments, can provide virtual resources to operating systems 330 or control programs 320 executing on virtual machines 332 in any manner that simulates the operating systems 330 or control programs 320 having direct access to system resources. System resources can include, but are not limited to, physical devices 306, physical disks 304, physical processors 308, physical memory 316 and any other component included in virtualization server 301 hardware layer 310. Hypervisor 302 may be used to emulate virtual hardware, partition physical hardware, virtualize physical hardware, and/or execute virtual machines that provide access to computing environments. In still other embodiments, hypervisor 302 controls processor scheduling and memory partitioning for a virtual machine 332 executing on virtualization server 301. Hypervisor 302 may include those manufactured by VMWare, Inc., of Palo Alto, Calif.; the XEN hypervisor, an open source product whose development is overseen by the open source Xen.org community; HyperV, VirtualServer or virtual PC hypervisors provided by Microsoft, or others. In some embodiments, virtualization server 301 executes a hypervisor 302 that creates a virtual machine platform on which guest operating systems may execute. In these embodiments, the virtualization server 301 may be referred to as a host server. An example of such a virtualization server is the XEN SERVER provided by Citrix Systems, Inc., of Fort Lauderdale, Fla.

Hypervisor 302 may create one or more virtual machines 332B-C (generally 332) in which guest operating systems 330 execute. In some embodiments, hypervisor 302 may load a virtual machine image to create a virtual machine 332. In other embodiments, the hypervisor 302 may execute a guest operating system 330 within virtual machine 332. In still other embodiments, virtual machine 332 may execute guest operating systems 330AB.

In addition to creating virtual machines 332, hypervisor 302 may control the execution of at least one virtual machine 332. In other embodiments, hypervisor 302 may present at least one virtual machine 332 with an abstraction of at least one hardware resource provided by the virtualization server 301 (e.g., any hardware resource available within the hardware layer 310). In other embodiments, hypervisor 302 may control the manner in which virtual machines 332 access physical processors 308 available in virtualization server 301. Controlling access to physical processors 308 may include determining whether a virtual machine 332 should have access to a processor 308, and how physical processor capabilities are presented to the virtual machine 332.

As shown in FIG. 3, virtualization server 301 may host or execute one or more virtual machines 332. A virtual machine 332 is a set of executable instructions that, when executed by a processor 308, imitate the operation of a physical computer such that the virtual machine 332 can execute programs and processes much like a physical computing device. While FIG. 3 illustrates an embodiment where a virtualization server 301 hosts three virtual machines 332, in other embodiments virtualization server 301 can host any number of virtual machines 332. Hypervisor 302, in some embodiments, provides each virtual machine 332 with a unique virtual view of the physical hardware, memory, processor and other system resources available to that virtual machine 332. In some embodiments, the unique virtual view can be based on one or more of virtual machine permissions, application of a policy engine to one or more virtual machine identifiers, a user accessing a virtual machine, the applications executing on a virtual machine, networks accessed by a virtual machine, or any other desired criteria. For instance, hypervisor 302 may create one or more unsecure virtual machines 332 and one or more secure virtual machines 332. Unsecure virtual machines 332 may be prevented from accessing resources, hardware, memory locations, and programs that secure virtual machines 332 may be permitted to access. In other embodiments, hypervisor 302 may provide each virtual machine 332 with a substantially similar virtual view of the physical hardware, memory, processor and other system resources available to the virtual machines 332.

Each virtual machine 332 may include a virtual disk 326A-C (generally 326) and a virtual processor 328A-C (generally 328.) The virtual disk 326, in some embodiments, is a virtualized view of one or more physical disks 304 of the virtualization server 301, or a portion of one or more physical disks 304 of the virtualization server 301. The virtualized view of the physical disks 304 can be generated, provided and managed by the hypervisor 302. In some embodiments, hypervisor 302 provides each virtual machine 332 with a unique view of the physical disks 304. Thus, in these embodiments, the particular virtual disk 326 included in each virtual machine 332 can be unique when compared with the other virtual disks 326.

A virtual processor 328 can be a virtualized view of one or more physical processors 308 of the virtualization server 301. In some embodiments, the virtualized view of the physical processors 308 can be generated, provided and managed by hypervisor 302. In some embodiments, virtual processor 328 has substantially all of the same characteristics of at least one physical processor 308. In other embodiments, virtual processor 308 provides a modified view of physical processors 308 such that at least some of the characteristics of the virtual processor 328 are different than the characteristics of the corresponding physical processor 308.

With further reference to FIG. 4, some aspects described herein may be implemented in a cloud-based environment. FIG. 4 illustrates an example of a cloud computing environment (or cloud system) 400. As seen in FIG. 4, one or more client computers 411-4nn may communicate with a management server 410 to access the computing resources (e.g., host servers 403, data storage devices 404, and network resources 405) of the cloud system.

Management server 410 may be implemented on one or more physical servers. The management server 410 may run, for example, CLOUDSTACK by Citrix Systems, Inc. of Ft. Lauderdale, Fla., or OPENSTACK, among others. Management server 410 may manage various computing resources, including cloud hardware and software resources, for example, host computers 403, data storage devices 404, and networking devices 405. The cloud hardware and software resources may include private and/or public components. For example, a cloud may be configured as a private cloud to be used by one or more particular customers or client computers 411-4nn and/or over a private network. In other embodiments, public clouds or hybrid public-private clouds may be used by other customers over one or more open and/or hybrid networks.

Management server 410 may be configured to provide user interfaces through which cloud operators and cloud customers may interact with the cloud system. For example, the management server 410 may provide a set of APIs and/or one or more cloud operator console applications (e.g., web-based on standalone applications) with user interfaces to allow cloud operators to manage the cloud resources, configure the virtualization layer, manage customer accounts, and perform other cloud administration tasks. The management server 410 also may include a set of APIs and/or one or more customer console applications with user interfaces configured to receive cloud computing requests from end users via one or more client computers 411-4nn, for example. The management server 410 may also receive requests to create, modify, or destroy virtual machines within the cloud. Client computers 411-4nn may connect to management server 410 via the Internet or other communication network, and may request access to one or more of the computing resources managed by management server 410. In response to client requests, the management server 410 may include a resource manager configured to select and provision physical resources in the hardware layer of the cloud system based on the client requests. For example, the management server 410 and additional components of the cloud system may be configured to provision, create, and manage virtual machines and their operating environments (e.g., hypervisors, storage resources, services offered by the network elements, etc.) for customers at one or more client computers 411-4nn, over a network (e.g., the Internet), providing customers with computational resources, data storage services, networking capabilities, and computer platform and application support. Cloud systems also may be configured to provide various specific services, including security systems, development environments, user interfaces, and the like.

Certain clients of the one or more clients 411-4nn may be related, for example, different client computers creating virtual machines on behalf of the same end user, or different users affiliated with the same company or organization. In other examples, certain clients 411-4nn may be unrelated, such as users affiliated with different companies or organizations. For unrelated clients, information on the virtual machines or storage of any one user may be hidden from other users.

Referring now to the physical hardware layer of a cloud computing environment, availability zones 401-402 (or plurality of zones) may refer to a collocated set of physical computing resources. Zones may be geographically separated from other zones in the overall cloud of computing resources. For example, zone 401 may be a first cloud datacenter located in California, and zone 402 may be a second cloud datacenter located in Florida. Management sever 410 may be located at one of the availability zones, or at a separate location. Each zone may include an internal network that interfaces with devices that are outside of the zone, such as the management server 410, through a gateway. End users of the cloud (e.g., clients 411-4nn) might or might not be aware of the distinctions between zones. For example, an end user may request the creation of a virtual machine having a specified amount of memory, processing power, and network capabilities. The management server 410 may respond to the user's request and may allocate the resources to create the virtual machine without the user knowing whether the virtual machine was created using resources from zone 401 or zone 402. In other examples, the cloud system may allow end users to request that virtual machines (or other cloud resources) are allocated in a specific zone or on specific resources 403-405 within a zone.

In this example, each zone 401-402 may include an arrangement of various physical hardware components (or computing resources) 403-405, for example, physical hosting resources (or processing resources), physical network resources, physical storage resources, switches, and additional hardware resources that may be used to provide cloud computing services to customers. The physical hosting resources in a cloud zones 401-402 may include one or more computer servers 403, such as the virtualization servers 301 described above, which may be configured to create and host virtual machine instances. The physical network resources in cloud zone 401 or 402 may include one or more network elements 405 (e.g., network service providers) comprising hardware and/or software configured to provide a network service to cloud customers, such as firewalls, network address translators, load balancers, virtual private network (VPN) gateways, Dynamic Host Configuration Protocol (DHCP) routers, and the like. The storage resources in the cloud zone 401-402 may include storage disks (e.g., solid state drives (SSDs), magnetic hard disks, etc.) and other storage devices.

The example cloud computing environment shown in FIG. 4 also may include a virtualization layer (e.g., as represented by the virtual machines shown in FIG. 3) with additional hardware and/or software resources configured to create and manage the virtual machines and provide other services to customers using the physical resources in the cloud. The virtualization layer may also include hypervisors, as described above in FIG. 3, along with other components to provide network virtualizations, storage virtualizations, etc. The virtualization layer may function as a separate layer from the physical resource layer, or may share some or all of the same hardware and/or software resources with the physical resource layer. For example, the virtualization layer may include a hypervisor installed in each of the one or more servers 403. Known cloud systems may alternatively be used, e.g., WINDOWS AZURE (Microsoft Corporation of Redmond Wash.), AMAZON EC2 (Amazon.com Inc. of Seattle, Wash.), IBM BLUE CLOUD (IBM Corporation of Armonk, N.Y.), or others. Each of the one or more servers 403 may comprise the virtualization server described in connection with FIG. 3.

FIG. 5 is an operational flow diagram for providing a method of migrating applications, data, and settings from a plurality of computing devices of an organization into a client server operating environment employing a thin client implementation.

At step 504, one or more telemetry gathering agents are installed in one or more endpoint computing devices. The endpoint computing devices may comprise the client computers described in connection with FIG. 1 or the client, client devices, client computing devices, or terminals described in connection with FIG. 2. Each of the one or more telemetry gathering agents may be software that is used to monitor and determine the applications, data, and settings in a computing device to be migrated to the thin client implementation. A telemetry gathering agent may be installed on each endpoint computing device via end user installation or application delivery through a server, such as the management server previously described in connection with FIG. 4.

Next, at step 508, data is collected from each computing device of the one or more computing devices. The operating system, user applications, and user layers may be identified, defined, and collected. Existing virtual environments such as a Windows client and server application, for example, may also be identified and defined. User data and settings with respect to the types of mobile devices, user applications may also be identified, defined, and collected. The telemetry gathering agent may also gather information about locations wherein data is stored by the computing device. For example, the data may be stored at a cloud data provider (ShareFile, Box, DropBox, etc.). The data collected from each computing device may be used to prepare a plan for migration to the thin client virtual desktop implementation. The aggregate telemetry data may be analyzed by a server of the one or more servers 403 described in connection with FIG. 4.

The collected data may be stored in a data storage device such as the one or more storage devices associated with the servers described in connection with FIG. 4. In cloud based storage repositories, telemetry data may be gathered by a telemetry gathering agent and uploaded to citrix.com or another storage repository managing website. In addition to the cloud based storage repository, in some aspects, the migrating organization may choose to deploy on-premise versions of the telemetry data repository as well. In other aspects, the migrating organization may choose to deploy only on-premise versions of the telemetry gathering agent. For on-premise based storage repositories, data may be gathered by the telemetry gathering agents and uploaded to an on-premise version of the cloud-based storage depositories described above.

Citrix or any manufacturer of a thin client migration application tool maymine the telemetry data (if desired and permitted by a migrating organization) obtained from a telemetry gathering agent. For simplicity, the telemetry gathering agents may be deployed as a virtual appliance for easy import into existing hypervisor deployments.

At step 512, the data downloaded by the telemetry gathering agents may be inventoried, analyzed, and categorized. For example, once a sufficient amount of data has been gathered in a telemetry storage repository, a software tool may be used for analyzing the stored data. The data may be downloaded continuously or periodically from each of the one or more computing devices of the organization. The inventory may at a point in time provide the state of the organization's system for each of the one or more endpoints.

Next, at step 516, the subset of data that is unique to each of the one or more computing devices is identified. The data included in this subset may comprise one or more applications uniquely used by the user of a computing device of the one or more computing devices. These one or more applications may have been installed by the user of the computing device. Other examples of data in the subset include user data and user settings. For example, data configured by the user for his camera or his mobile communications device may be included in the subset. The data may be configured by the user when the camera or mobile communications device is communicatively coupled to his computing device. Other data may also be unique to the user and/or the user's computing device.

At step 520, the subset of data may be extracted for each of the one or more computing devices. The subset of data may be used to create a personalization layer for each of the one or more computing devices of the organization. The personalization layer may alternatively be described as a personalization image. The data associated with the personalization layer may be stored as a personalized virtualization disk (PVD) and contains the unique personalized image for each of the one or more computing devices or endpoint computing devices. The personalized image contains all of the user data, user settings, and user applications unique to its computing device. The personalization layer may contain user-specific and departmental-specific applications, data, and settings of the organization. The personalization layer or image may be stored in a data storage device of the one or more data storage devices previously described in connection with FIG. 4. A corresponding server may use the personalization layer or image to generate a corresponding virtual machine. The virtual machine may retain all of the user data settings, user data, and user applications that were available in its corresponding computing device prior to the migration.

Next, at step 524, the one or more servers described in connection with FIG. 4 may continue to monitor the one or more client computing devices for changes. Once a majority of an enterprise's endpoints have been migrated, the system, by way of each telemetry gathering agent, may continually monitor the needs of each client over time. Appropriate metrics and monitoring solutions may be installed for measuring the inventory of each client computing device after the migration. Statistics related to the performance of the virtualized desktops when the PVD is used may be obtained via the existing telemetry gathering agents and may be provided to administrators of the thin client virtual desktop implementation. Some of the telemetry data that can be gathered on an ongoing basis may include: device statistics, user information, application information, usage information, bandwidth, mobile device information.

FIG. 6 is an operational flow diagram for providing a method of generating a personalized virtualization disk (PVD) for each of one or more endpoints (or endpoint computing devices) of an organization. The generation of a PVD facilitates an organization's migration to a thin client virtual desktop implementation. The method of FIG. 6 may describe steps 516 and 520 of FIG. 5, after data is obtained from the telemetry gathering agents from the one or more endpoints or computing devices.

At step 604, the operating system to be used in the thin client virtual desktop implementation may be determined. A “plain vanilla” image may be defined as comprising an operating system, its service packs, and any related updates, and which is or will be common to all virtual desktops. The operating system chosen may comprise Windows 7, for example. Other operating systems may also be used.

Next, at step 608, software corresponding to a “gold image” for use by all virtual machines in the organization may be determined. This inventory of software comprises the plain vanilla image and any other software that will be commonly used by the entire organization. The organization may determine additional software to be included in the gold image. Software that will be commonly used throughout the entire organization may be included in the gold image. The gold image may comprise a word processing application, a spreadsheet application, a presentation application, and/or e-mail application, for example. Such applications may be deployed by way of a site license obtained from the software manufacturer, for example.

At step 612, the plain vanilla image is subtracted from the gold image to yield a first difference (D1) image. The D1 image may be stored in a storage repository, such as the one or more data storage devices described in connection with FIGS. 3 and/or 4. The D1 image corresponds to administratively installed applications that are common to all users throughout the organization. As previously described in step 608, these applications may be included in the gold image based on decision made by the organization's administration. The decision to include these applications into the gold image may be based on the rate of utilization of these applications by users of the organization. If a certain percentage of users of the organization require use of an application, the application may be included into the gold image by way of purchasing a site license, for example.

Next, at step 616, an image of the inventory of software for each endpoint (or endpoint computing device) is determined. In addition to the software included in the gold image, the inventory at each endpoint may comprise any software and/or application installed by the user of each endpoint computing device, including user data and user settings. The software and/or application installed at each endpoint may optionally comprise departmentally administered software and/or applications.

At step 620, the plain vanilla image is subtracted from the image for each endpoint to yield a second difference (D2). The D2 image may be stored in a storage repository, such as the one or more data storage devices described in connection with FIGS. 3 and 4. The D2 image corresponds to the administratively installed applications that are commonly used throughout the organization plus any user installed applications, user data, and user settings.

Next, at step 624, a difference is computed between the D2 image and the D1 image. A D2-D1 image may be computed for each endpoint. The D2-D1 image may comprise user installed applications, user data, and user settings for each endpoint of the one or more endpoints (one or more computing devices). The D2-D1 image may further comprise departmentally administered applications or applications specific to a department of the organization. Each D2-D1 image may be used to generate a PVD for each endpoint or computing device. For each endpoint, its respective PVD may be stored in a data storage device such as the data storage device described in connection with FIGS. 3 and 4. After all PVDs have been created, the PVDs may be executed by a server of the one or more servers described in connected with FIG. 4. The server may comprise the virtualization server previously described in connection with FIG. 3. Thus, by way of constructing a PVD for each endpoint, a migration to a thin client virtualized desktop implementation may be easily performed by the organization without loss of user applications and personalized settings and data.

FIG. 7 is an operational flow diagram for providing a method of generating a personalized virtualization disk (PVD) for an endpoint of one or more endpoints (or endpoint computing devices) of an organization. The generation of a PVD facilitates an organization's migration to a thin client virtual desktop implementation. The method described in FIG. 7 may describe steps 516 and 520 of FIG. 5, after data is obtained from the telemetry gathering agents from the one or more endpoints or computing devices.

At step 704, a personalized virtualization disk (PVD) may be allocated and assigned to an endpoint computing device using the collected data. A pre-migrational PVD may comprise software comprising the endpoint computing device's vanilla and gold images, and any user installed applications, user data, and user settings.

In one embodiment, a cataloguing mechanism may be employed to determine the sequence of software installation for each of the one or more endpoint computing devices of the organization. The cataloguing mechanism may be deployed by the management server or one or more computer servers previously described in connection with FIGS. 3-4. The cataloguing mechanism may create and store a data log describing the installation sequence for software installed in an endpoint computing device. The data log may be stored as a file in the management server and/or one or more computing servers previously described in connection with FIGS. 3-4. The data regarding the installation sequence may be used to identify and de-install a “plain vanilla” image and a “gold image” corresponding to the endpoint computing device. The plain vanilla image may comprise an operating system, its service packs, and any related updates, for example. The gold image may comprise software that may be commonly used throughout the entire organization. The gold image may comprise a word processing application, a spreadsheet application, a presentation application, and/or e-mail application, for example. Such applications may be deployed by way of a site license obtained from the software manufacturer, for example.

Next, at step 708, software may be sequentially removed or de-installed from the pre-migrational PVD of the endpoint computing device, by way of using the data log. A typical endpoint, prior to a migration, may comprise an operating system, its service packs, and any related updates, system-specific software (hardware drivers and software suites unique to the endpoint), platform software (e.g., .NET, Java), security software such as antivirus software, antispy software, anti-malware, firewall software, departmentally administered applications, user installed applications, user settings, and user data. The data log describing the installation sequence may be used to identify and sequentially remove image data other than that corresponding to the user installed applications, user data, user settings, and departmentally administered applications (or applications specific to a department of the organization), for each endpoint computing device. For example, the plain vanilla image and the gold image may be deleted or removed from the pre-migrational PVD of each endpoint computing device. The gold image may comprise software commonly used throughout the entire organization. The gold image may comprise one or more applications that are used throughout the organization, such as a word processing application, a spreadsheet application, a presentation application, and/or mail application, for example.

At step 712, a PVD may be generated for each endpoint or computing device after the plain vanilla and gold images are deleted from the pre-migrational PVD. The finalized PVD may comprise only the software unique to the endpoint computing device. For example, the finalized PVD may comprise user installed applications, user data, user settings, and optionally any departmentally administered applications corresponding to each endpoint computing device. The PVD may be stored at a data storage device previously described in connection with FIGS. 3 and 4. After all PVDs have been created, the PVDs may be executed by a computer server of the one or more computer servers described in connected with FIG. 4. The computer server may comprise the virtualization server previously described in connection with FIG. 3. Thus, by way of constructing a PVD for each endpoint, a migration to a thin client virtualized desktop implementation may be easily performed by the organization without modification, change, or loss of user applications and/or personalized settings and data.

Aspects of the disclosure may be implemented in one or more of the embodiments described below.

In one embodiment, a system comprises at least one processor; and at least one memory storing computer executable instructions that, when executed by said at least one processor, cause the system to collect data from each endpoint computing device of a plurality of endpoint computing devices, create a personalized virtualization disk based on said data for said each endpoint computing device, use said personalized virtualization disk for said each endpoint computing device to implement a thin client virtualized desktop, and wherein said personalized virtualization disk is used to generate one or more user installed applications, user data, and user settings corresponding to said each endpoint computing device.

In another embodiment of the system, the personalized virtualization disk is created by de-installing software from an image based on said collected data, wherein said software comprises an operating system, and one or more applications that are commonly used throughout said plurality of endpoint computing devices.

In another embodiment of the system, the software further comprises service packs and any related updates associated with said operating system.

In another embodiment of the system, the one or more applications comprise a word processing application.

In another embodiment of the system, one or more telemetry gathering agents are installed in one or more of said plurality of endpoint computing devices, said telemetry gathering agents used for said collecting said data.

In another embodiment of the system, the one or more telemetry gathering agents are used to continually monitor and update said data collected from said each of said one or more plurality of endpoint computing devices.

In another embodiment of the system, the personalized virtualization disk comprises an image used for generating departmentally administered applications.

In a further embodiment a method comprises collecting data from each endpoint computing device of a plurality of endpoint computing devices using one or more telemetry gathering agents; creating a personalized virtualization disk based on said data for said each endpoint computing device; and using said personalized virtualization disk for each said endpoint computing device to implement a thin client virtualized desktop, wherein said personalized virtualization disk is used to generate one or more user installed applications, user data, and user settings corresponding to said each endpoint computing device, and wherein said creating is performed by a host computing device.

In another embodiment of the method, the personalized virtualization disk is created by de-installing software from an image based on said collected data, wherein said software comprises an operating system, and one or more applications that are commonly used throughout said plurality of endpoint computing devices.

In another embodiment of the method, the software further comprises service packs and any related updates associated with said operating system.

In another embodiment of the method, the one or more applications comprise a word processing application.

In another embodiment of the method, one or more telemetry gathering agents are installed in one or more of said plurality of endpoint computing devices, said telemetry gathering agents used for said collecting said data.

In another embodiment of the method, one or more telemetry gathering agents are used to continually monitor and update said data collected from said each of said one or more plurality of endpoint computing devices.

In another embodiment of the method, the personalized virtualization disk comprises an image used for generating departmentally administered applications.

In an additional embodiment, a non-transitory computer-readable storage media having stored thereon, a computer program having at least one code section for processing data, said at least one code section being executable by at least one processor of said computer for causing the computer to perform a method that comprises collecting data from each endpoint computing device of a plurality of endpoint computing devices using one or more telemetry gathering agents, creating a personalized virtualization disk based on said data for said each endpoint computing device, using said personalized virtualization disk for said each endpoint computing device to implement a thin client virtualized desktop, wherein said personalized virtualization disk is used to generate one or more user installed applications, user data, and user settings corresponding to said each endpoint computing device.

In another embodiment of the non-transitory computer-readable storage media, the personalized virtualization disk is created by de-installing software from an image based on said collected data, wherein said software comprises an operating system, and one or more applications that are commonly used throughout said plurality of endpoint computing devices.

In another embodiment of the non-transitory computer-readable storage media, the software further comprises service packs and any related updates associated with said operating system.

In another embodiment of the non-transitory computer-readable storage media, the one or more applications comprise a word processing application.

In another embodiment of the non-transitory computer-readable storage media, one or more telemetry gathering agents are installed in one or more of said plurality of endpoint computing devices, said telemetry gathering agents used for said collecting said data.

In another embodiment of the non-transitory computer-readable storage media, the one or more telemetry gathering agents are used to continually monitor and update said data collected from said each of said one or more plurality of endpoint computing devices.

Although the subject matter has been described in language specific to structural features and/or methodological acts, it is to be understood that the subject matter defined in the appended claims is not necessarily limited to the specific features or acts described above. Rather, the specific features and acts described above are described as example implementations of the following claims.

1. (canceled)

2. A system comprising:
at least one processor; and
at least one memory storing computer executable instructions that, when executed by said at least one processor, cause the system to:
collect data from each endpoint computing device of a plurality of endpoint computing devices;
create a personalized virtualization disk based on said data for said each endpoint computing device;
use said personalized virtualization disk for said each endpoint computing device to implement a thin client virtualized desktop; and
wherein said personalized virtualization disk is used to generate one or more user installed applications, user data, and user settings corresponding to said each endpoint computing device.

3. The system of claim 2, wherein said personalized virtualization disk is created by de-installing software from an image based on said collected data, wherein said software comprises:
an operating system; and
one or more applications that are commonly used throughout said plurality of endpoint computing devices.

4. The system of claim 3 wherein said software further comprises service packs and any related updates associated with said operating system.

5. The system of claim 3 wherein said one or more applications comprises a word processing application.

6. The system of claim 2 wherein one or more telemetry gathering agents are installed in one or more of said plurality of endpoint computing devices, said telemetry gathering agents used for said collecting said data.

7. The system of claim 6 wherein said one or more telemetry gathering agents are used to continually monitor and update said data collected from said each of said one or more plurality of endpoint computing devices.

8. The system of claim 7 wherein said personalized virtualization disk comprises an image used for generating departmentally administered applications.

9. A method comprising:
collecting data from each endpoint computing device of a plurality of endpoint computing devices using one or more telemetry gathering agents;
creating a personalized virtualization disk based on said data for said each endpoint computing device; and
using said personalized virtualization disk for each said endpoint computing device to implement a thin client virtualized desktop, wherein said personalized virtualization disk is used to generate one or more user installed applications, user data, and user settings corresponding to said each endpoint computing device, and wherein said creating is performed by a host computing device.

10. The method of claim 9, wherein said personalized virtualization disk is created by de-installing software from an image based on said collected data, wherein said software comprises:
an operating system; and
one or more applications that are commonly used throughout said plurality of endpoint computing devices.

11. The method of claim 10 wherein said software further comprises service packs and any related updates associated with said operating system.

12. The method of claim 10 wherein said one or more applications comprises a word processing application.

13. The method of claim 9 wherein one or more telemetry gathering agents are installed in one or more of said plurality of endpoint computing devices, said telemetry gathering agents used for said collecting said data.

14. The method of claim 13 wherein said one or more telemetry gathering agents are used to continually monitor and update said data collected from said each of said one or more plurality of endpoint computing devices.

15. The method of claim 9 wherein said personalized virtualization disk comprises an image used for generating departmentally administered applications.

16. A non-transitory computer-readable storage media having stored thereon, a computer program having at least one code section for processing data, said at least one code section being executable by at least one processor of said computer for causing the computer to perform a method comprising:
collecting data from each endpoint computing device of a plurality of endpoint computing devices using one or more telemetry gathering agents;
creating a personalized virtualization disk based on said data for said each endpoint computing device; and
using said personalized virtualization disk for said each endpoint computing device to implement a thin client virtualized desktop, wherein said personalized virtualization disk is used to generate one or more user installed applications, user data, and user settings corresponding to said each endpoint computing device.

17. The non-transitory computer-readable storage media of claim 16, wherein said personalized virtualization disk is created by de-installing software from an image based on said collected data, wherein said software comprises:
an operating system; and
one or more applications that are commonly used throughout said plurality of endpoint computing devices.

18. The non-transitory computer-readable storage media of claim 17 wherein said software further comprises service packs and any related updates associated with said operating system.

19. The non-transitory computer-readable storage media of claim 17 wherein said one or more applications comprises a word processing application.

20. The non-transitory computer-readable storage media of claim 16 wherein one or more telemetry gathering agents are installed in one or more of said plurality of endpoint computing devices, said telemetry gathering agents used for said collecting said data.

21. The non-transitory computer-readable storage media of claim 20 wherein said one or more telemetry gathering agents are used to continually monitor and update said data collected from said each of said one or more plurality of endpoint computing devices.
